(19) United States
(12) Patent Application Publication
(10) Pub. No.: US 2009/0194140 A1
(43) Pub. Date: Aug. 6, 2009

(54) Semiconductor Substrate Cleaning Apparatus

(76) Inventor: Yung-Shun PAN, Shulin City (TW)

Correspondence Address: SINORICA, LLC, 2275 Research Blvd., Suite 500, ROCKVILLE, MD, 20850, US

(21) Appl. No.: 12/261,497

(22) Filed: Oct. 30, 2008

(30) Foreign Application Priority Data
Feb. 5, 2008 (TW) 097104425

(51) Int. Cl. B08B 13/00

(52) U.S. Cl. 134/172

(57) ABSTRACT

A semiconductor substrate cleaning and reticle cleaning apparatus, and more particularly, a cleaning apparatus used to remove contaminants from the surface of the semiconductor substrate and the reticle in the semiconductor process, is disclosed in the present invention. The cleaning apparatus comprises a working platform, a base unit, and an adjustable cleaning unit. The base unit is composed of two vertical baseboards in parallel to each other and each vertical baseboard has a bottom end and a top end. The bottom ends of two vertical baseboards are placed on the working platform. The adjustable cleaning unit is pivotally disposed on the top ends of two vertical baseboards, wherein the adjustable cleaning unit comprises at least a long slot for transmitting a fluid to a surface of a semiconductor substrate or a reticle.

### BACKGROUND OF THE INVENTION

1. Field of the Invention

The present invention provides a semiconductor substrate cleaning and reticle cleaning apparatus, and more particularly, to a cleaning apparatus used to remove contaminants from the surface of the semiconductor substrate and the reticle in the semiconductor process.

2. Description of the Prior Art

In the semiconductor process, the step of cleaning semiconductor substrate or reticle is a very important step. In the process of cleaning, all organic materials, contaminants, and chemical residuals that remain on the surface of semiconductor substrate or reticle have to be efficiently and thoroughly cleaned. Otherwise, contaminated reticle will lead to serious loss of product yield in the following process.

Referring to what is shown in FIG. 1, which is a side view of a conventional reticle cleaning apparatus. In this reticle cleaning apparatus 100, a horizontal reticle fixing unit 120 disposed on rotation platform 110 is used for fixing the reticle R, and an adjustable cleaning spray nozzle 130 is used to generate forceful water flow or gas flow for flushing the surface of reticle R. However, the range of water flow or gas flow sprayed by such design of spray nozzle 130 is limited, and obviously, it takes considerably long period of time to clean only one of the surfaces of reticle R. And when another surface of reticle R needs to be cleaned, the reticle R needs to be turned over, fixed, and then cleaned again, which is not only time-consuming but also more risky. Moreover, in the process of cleaning, centrifugal force needs to be generated by the horizontal rotation of the rotation platform 110 to make it hard for particles or contaminants to adhere; wherein when the rotating speed of the rotation platform 110 is increased, it is possible for reticle R to come off, which will thus lead to crack of edge of reticle R.

In view of what is described above, the semiconductor substrate cleaning and reticle cleaning apparatus provided by the present invention makes improvements based on the prior art.

### SUMMARY OF THE INVENTION

In view of the defects and problems of the reticle cleaning apparatus of the prior art, one objective of the present invention is to provide a semiconductor substrate and reticle cleaning apparatus, in which the spray nozzle is designed as a long slot for evenly spraying out fluid in large amount to effectively remove particles or contaminants from the surface of semiconductor substrate and reticle to enhance the yield of semiconductor process.

Another objective of the present invention is to provide a semiconductor substrate and reticle cleaning apparatus, the spray nozzle of the cleaning apparatus being designed as a long slot for evenly spraying out fluid in large amount to reduce the time for cleaning.

Still another objective of the present invention is to provide a semiconductor substrate and reticle cleaning apparatus with the direction and degree of fluid sprayed out by the cleaning apparatus being adjustable, and therefore the degree of fluid sprayed out by the cleaning apparatus can be adjusted to be the best according to the properties of particles or contaminants, and different sizes or materials of semiconductor substrate and reticle.

Yet another objective of the present invention is to provide a semiconductor substrate and reticle cleaning apparatus, which is able to clean two surfaces of reticle simultaneously and complete the procedure of cleaning in a fast, thorough way to achieve high time-efficiency.

And yet another objective of the present invention is to provide a semiconductor substrate and reticle cleaning apparatus, which includes at least a recycling apparatus that is able to instantly recycle fluid sprayed out and particles or contaminants dropped down to prevent the dropped particles or contaminants from adhering to the surface of the semiconductor substrate and reticle again.

The semiconductor substrate or reticle cleaning apparatus provided by the present invention comprises a working platform, a base unit, and an adjustable cleaning unit. The base unit is composed of two vertical baseboards in parallel to each other and each vertical baseboard has a bottom end and a top end. The bottom ends of two vertical baseboards are placed on the working platform and the top ends of vertical baseboards are pivotally disposed with the adjustable cleaning unit, wherein the adjustable cleaning unit comprises at least a long slot for transmitting a fluid to a surface of a semiconductor substrate or a reticle.

In addition, the cleaning apparatus of the present invention can also include two adjustable cleaning units, between which is a space for accommodating a reticle to allow the cleaning apparatus to clean two surfaces of reticle simultaneously.

The characteristics and practice of the present invention are thus described in detail in below depiction of the preferred embodiments in correspondence with drawings.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a side view of a conventional reticle cleaning apparatus;

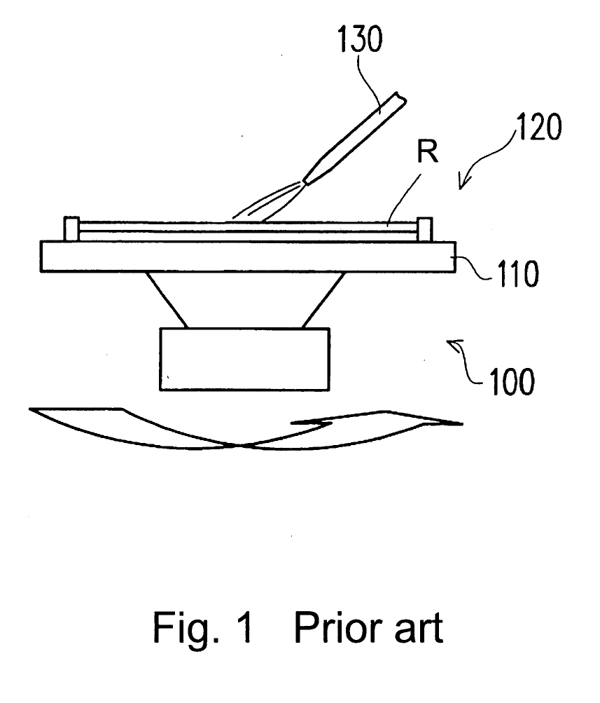

FIG. 2 is a full view of a cleaning apparatus of the present invention;

FIG. 3 is a full view of base unit and adjustable cleaning unit of cleaning apparatus of the present invention;

FIG. 4 is a side sectional view of adjustable cleaning unit of cleaning apparatus of the present invention;

FIG. 5 is another design of adjustable cleaning unit of the present invention;

FIG. 6 is a view of another embodiment of cleaning apparatus of the present invention; and

FIG. 7 is a full view of another cleaning apparatus of the present invention.

### DESCRIPTION OF THE PREFERRED EMBODIMENT

The preferred embodiments of the present invention are disclosed as follows but are not for limiting the scope of the present invention. Any modifications and similar arrangements without departing from spirit and scope of the present invention can also be made by those skilled in the art and still covered by the present invention. Therefore the scope of the present invention is only determined by the appended claims which are to be accorded the broadest interpretation.

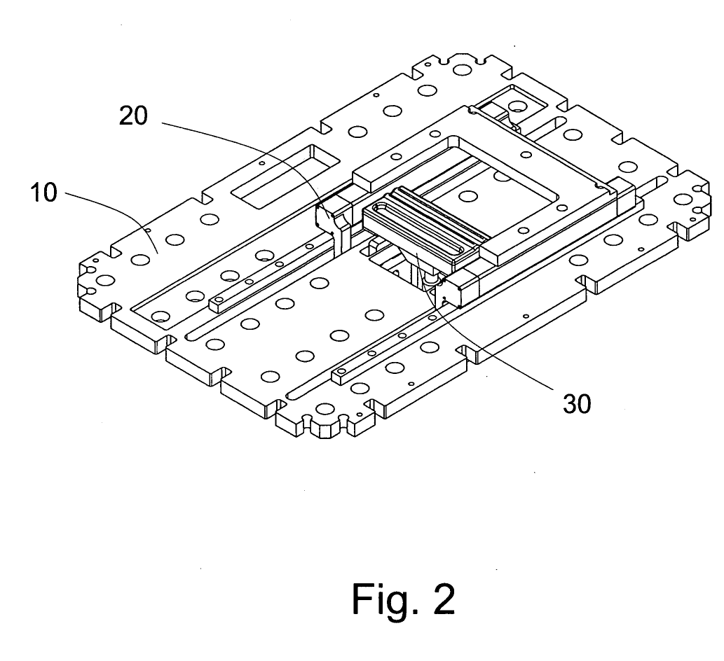

First, referring to FIG. 2, which is a full view of a cleaning apparatus of the present invention.

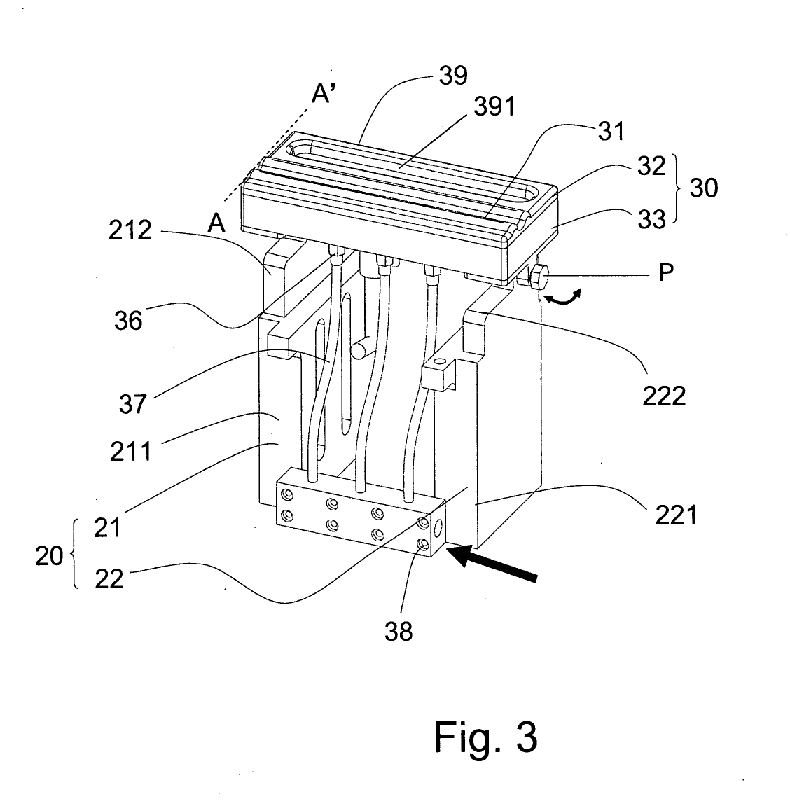

Then, referring to FIG. 3, which is a full view of base unit and adjustable cleaning unit of cleaning apparatus of the present invention. The cleaning apparatus of the present invention is used for cleaning semiconductor substrate or reticle. This cleaning apparatus comprises a working platform 10, a base unit 20, and an adjustable cleaning unit 30. The base unit 20 is composed of two vertical baseboards 21, 22 in parallel to each other and the vertical baseboards 21, 22 have bottom ends 211, 221 and top ends 212, 222. The bottom ends 211, 221 of two vertical baseboards 21, 22 are placed on the working platform 10 and the top ends 212, 222 of vertical baseboards 21, 22 are pivotally disposed with the adjustable cleaning unit 30, wherein the adjustable cleaning unit 30 comprises at least a long slot 31 for transmitting a fluid to a surface of a semiconductor substrate or a reticle.

The aforementioned semiconductor substrate can be glass substrate, silicon substrate, or substrate made of a compound. And its size can be 8″ wafer, 12″ wafer, 18″ wafer, LCD substrate, or substrate of other sizes. The fluid transmitted by the long slot 31 can be a liquid such as D. I. Water, with which the particles or contaminants on the surface of semiconductor substrate or reticle can be cleaned out. Of course, the fluid transmitted by the long slot 31 can also be a gas such as inert gas, cold, dry air, nitrogen, pure gas, or combination of the above and the gush of gas as described above is used to separate particles or contaminants on the surface of semiconductor substrate or reticle from the semiconductor substrate or reticle. Moreover, liquid can be first transmitted by the long slot 31 to the surface of semiconductor substrate or reticle, and after the particles or contaminants are separated from the semiconductor substrate or reticle, the aforementioned gas can then be transmitted to the surface of the semiconductor substrate or reticle to dry the liquid remaining on the surface of the semiconductor substrate or reticle.

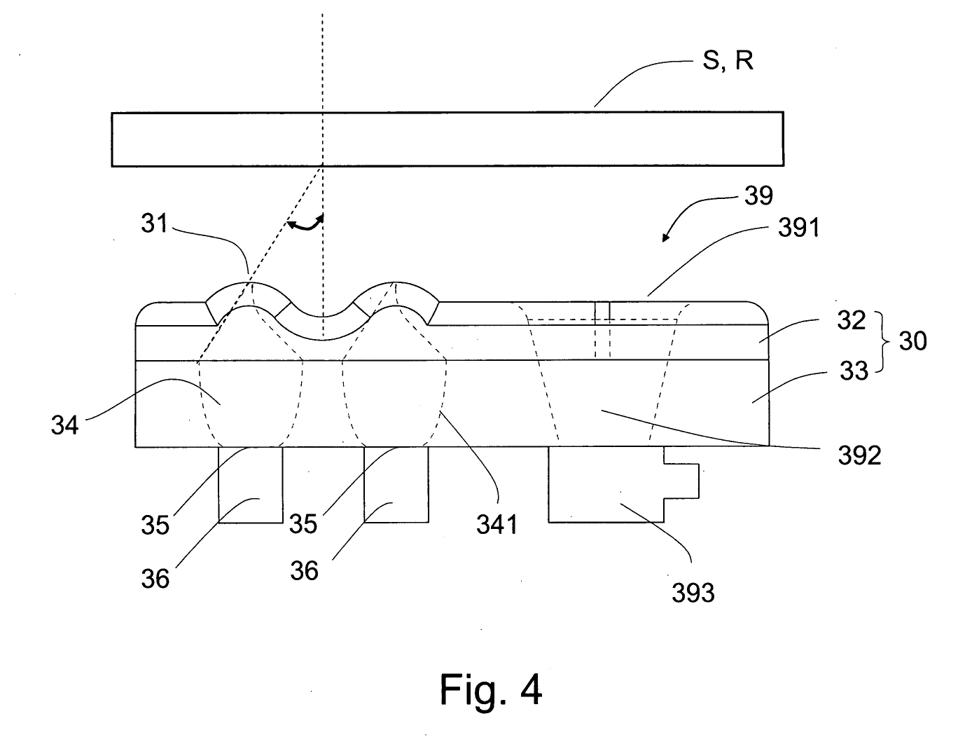

Then, referring to FIG. 4, which is a side sectional view (sectional view of A-A′) of adjustable cleaning unit 30 of cleaning apparatus in FIG. 3. It can be seen from the aforementioned FIG. 3 and FIG. 4, the adjustable cleaning unit 30 is a quasi-rectangular structure that can be disposed on one side of the surface of semiconductor substrate S or reticle R. The adjustable cleaning unit 30 is composed of an upper cover 32 with at least a space for accommodation and a lower cover 33 with at least a space for accommodation. Therefore, when the upper cover 32 and the lower cover 33 are fixedly connected, since the space for accommodation of the upper cover 32 and of the lower cover 33 are coupledly disposed, at least a fluid accommodating space 34 can be formed to accommodate fluid. And the aforementioned fluid accommodating space 34 includes a long slot 31 disposed on the top end of the upper cover 32 and comprises a fluid inlet 35 located at the lower cover 33. One end of the fluid inlet 35 is connected to a quick-to-connect coupler 36, and obviously, the fluid inlet 35 is connected to the long slot 31 through the fluid accommodating space 34. Moreover, the quick-to-connect coupler 36 is connected to the distributor block 38 via pipe 37 for fluid from a fluid source (as shown by arrow) to be sequentially transmitted through distributor block 38, pipe 37, quick-to-connect coupler 36, fluid inlet 35, fluid accommodating space 34, and long slot 31 to the surface of the semiconductor substrate S or reticle R. What is to be particularly emphasized is that, the bore or width of long slot 31 is much smaller than the bore or width of fluid inlet 35 or fluid accommodating space 34; and the nearer the fluid accommodating space 34 is to the long slot 31, the smaller its bore or width becomes. Therefore, the fluid sprayed out from this long slot 31 is similar to a water knife or air knife with enough pressure to separate particles or contaminants from semiconductor substrate S or reticle R to which they adhere. And in a preferred embodiment, each fluid accommodating space 34 is designed to be a structure with pear-shaped curve surface, as shown by dotted line 341 in FIG. 4, wherein since the structure of pear-shaped curve surface reduces the interference in the fluid accommodating space 34, the pressure of the long slot 31 can become higher.

And the length of long slot 31 as described above can be the width of semiconductor substrate S or reticle R or two-thirds of the width to provide larger cleaning range. And there is an included angle between the fluid sprayed out from the long slot 31 and the normal vector of the cleaned surface of semiconductor substrate S or reticle R, which makes it easier for particles or contaminants to be separated or come off and also prevents the semiconductor substrate S or reticle R from being impacted by larger frontal flushing force. And the included angle as described above can be about 25-30 degrees to achieve better effect. Moreover, since the adjustable cleaning unit 30 is fixed to the top ends 212, 222 of the two vertical baseboards 21, 22 of the base unit 20 via pivotal connection, thus the user can further adjust a pivot P (as shown in FIG. 3) on the adjustable cleaning unit 30 according to the properties of particles or contaminants and different sizes or materials of semiconductor substrate S or reticle R for the adjustable cleaning unit 30 to slant at an angle with respect to the base unit 20 in order to change the degree of the included angle between fluid sprayed out from long slot 31 and the cleaned surface of semiconductor substrate S or reticle R.

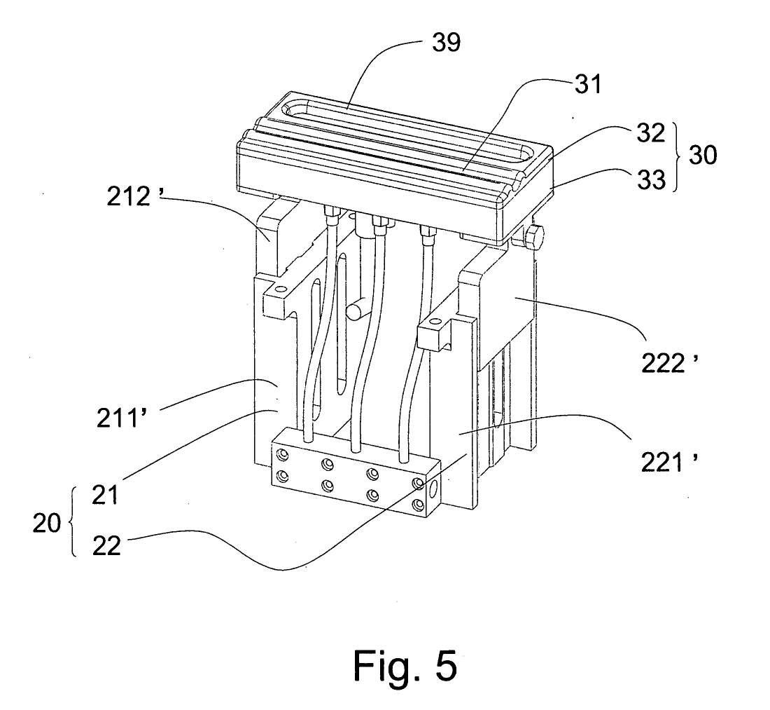

Then, referring to FIG. 5, which shows another design of adjustable cleaning unit 30 of the present invention. As shown in FIG. 5, the adjustable cleaning unit 30 can be further disposed with a recycling apparatus 39 for recycling fluid sprayed out from the long slot 31 and particles or contaminants separated to avoid secondary contamination of semiconductor substrate S or reticle R that may be caused by the fluid sprayed out or the particles or contaminants separated. Obviously, this recycling apparatus 39 is not connected to the long slot 31; therefore the recycling apparatus 39 can also be separated from the adjustable cleaning unit 30, which is not limited in the present invention. As shown in FIG. 4 and FIG. 5, the recycling apparatus 39 includes a collection opening 391 which is located on one lateral side of the adjustable cleaning unit 30, and extending downward from the collection opening 391 is a collection space 392 and a recycling pipe 393, with which a fluid discharge apparatus (not shown in Figure) can be used to draw fluid sprayed out from the long slot 31 and the particles or contaminants separated into the collection space 392 via the collection opening 391 and then carry fluid and particles or contaminants away from the cleaning apparatus of the present invention via the recycling pipe 393.

As shown in FIG. 5, the base unit 20 of cleaning apparatus of the present invention can also be a base unit with longitudinally or vertically adjustable height. The vertical baseboards 21, 22 of this base unit 20 can be composed of inner vertical baseboards 211′, 221′ and outer vertical baseboards 212′, 222′. The inner vertical baseboards 211′, 221′ are fixed to the working platform 10, and the outer vertical baseboards 212′, 222′ are pivotally disposed with adjustable cleaning unit 30, wherein the inner vertical baseboards 211′, 221′ include a slide track for supporting the upward and downward movement of outer vertical baseboards 212′, 222′ with respect to inner vertical baseboards 211′, 221′ to adjust the vertical distance between the long slot 31 and semiconductor substrate or reticle. Of course, the aforementioned design can also be that the outer vertical baseboards can be fixed to the working platform and the inner vertical baseboards can move upward and downward with respect to the outer vertical baseboards.

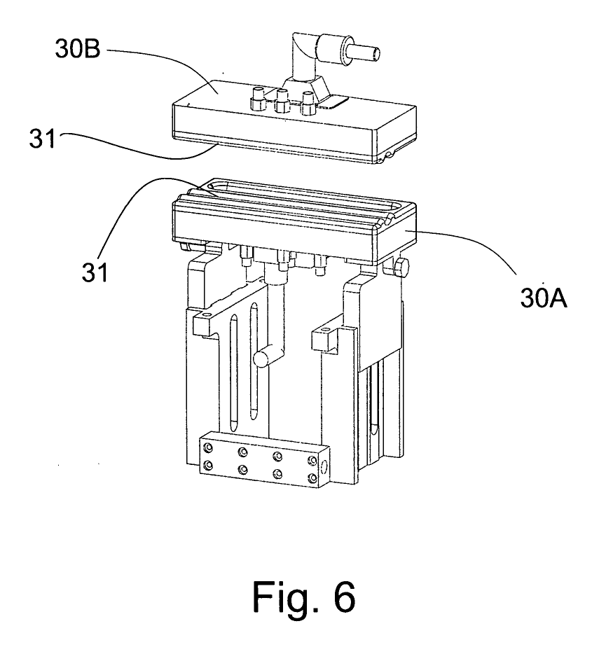

Then, referring to FIG. 6, which is a view of another embodiment of cleaning apparatus of the present invention. As shown in FIG. 6, the cleaning apparatus is composed of two adjustable cleaning units 30 oppositely disposed, wherein the adjustable cleaning unit 30A is fixedly connected to the working platform 10 and the adjustable cleaning unit 30B is oppositely disposed on top of the adjustable cleaning unit 30A for the long slots 31 of the two adjustable cleaning units 30A, 30B to be oppositely disposed as well. And between the two adjustable cleaning units 30 is a space that can accommodate a reticle or semiconductor substrate to allow the cleaning apparatuses 30A, 30B to clean the upper and lower surfaces of reticle or semiconductor substrate simultaneously.

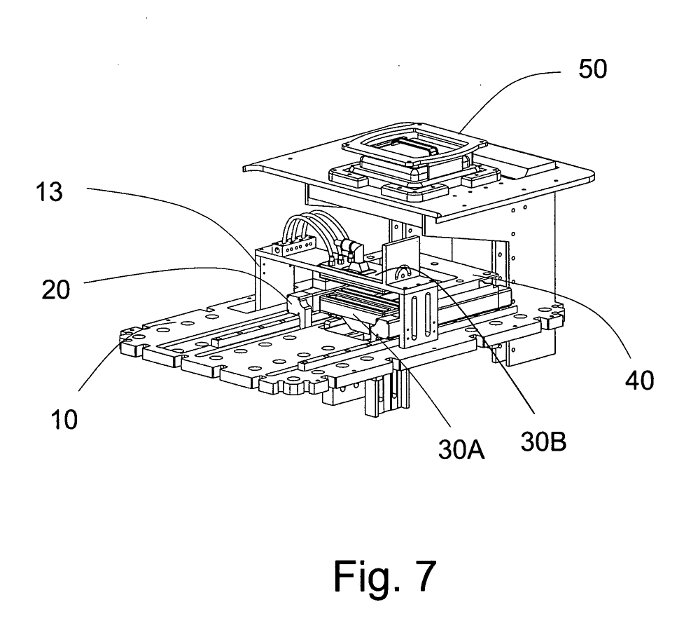

Then, as shown in FIG. 7, which is a full view of another cleaning apparatus of the present invention. Obviously, the adjustable cleaning unit 30A is fixedly connected to the working platform 10, and the adjustable cleaning unit 30B is disposed opposite to the adjustable cleaning unit 30A via a fixing frame 13. Moreover, the cleaning apparatus of the present invention is disposed with a displacement mechanism 40, which is located on the working platform 10. The displacement mechanism 40 comprises a fixing unit (not shown in Figure) for fixing semiconductor substrate or reticle and allows the semiconductor substrate or reticle to move horizontally above the working platform 10, i.e. moving between two adjustable cleaning units 30A, 30B, for the whole semiconductor substrate or reticle to be cleaned. Of course, the displacement mechanism 40 can also be designed for vertical upward/downward movement or inclined movement. The design of vertical upward/downward movement is for moving the semiconductor substrate or reticle from the original storage space 50 near the height of adjustable cleaning unit 30. And the design of inclined movement is for providing semiconductor substrate or reticle with some inclined angle in the process of cleaning semiconductor substrate or reticle, meaning that there is an included angle between the surface of semiconductor substrate or reticle and the working platform 10 to prevent liquid from remaining on the surface of semiconductor substrate or reticle.

Obviously, according to the description of the above embodiments, the present invention may include more modifications and differences. Therefore the present invention should be understood by the appended claims. In addition to the detailed description above, the present invention can also be extensively applied in other embodiments, and the aforementioned embodiments are only some preferred embodiments of the present invention and not for limiting the scope of the present invention. Any modifications and arrangements made without departing from the spirit disclosed by the present invention should be encompassed by the appended claims accorded with the broadest interpretation.

What is claimed is:

1. A semiconductor substrate cleaning apparatus, comprising:
a working platform;
a base unit, composed of two vertical baseboards in parallel to each other, said vertical baseboard having a bottom end and a top end, said bottom end of said vertical baseboard being disposed on said working platform; and
an adjustable cleaning unit, pivotally disposed on said top end of said two vertical baseboards of said base unit, wherein said adjustable cleaning unit comprises a long slot for transmitting a fluid to a surface of a semiconductor substrate.

2. The semiconductor substrate cleaning apparatus according to claim 1, wherein said semiconductor substrate is selected from the group consisting of: glass substrate, silicon substrate, and substrate made of compound material.

3. The semiconductor substrate cleaning apparatus according to claim 1, wherein said fluid is gas.

4. The semiconductor substrate cleaning apparatus according to claim 1, wherein said fluid is liquid.

5. The semiconductor substrate cleaning apparatus according to claim 1, wherein length of said long slot of said adjustable cleaning unit is about width of said semiconductor substrate.

6. The semiconductor substrate cleaning apparatus according to claim 1, wherein there is an included angle between said fluid sprayed out by said long slot of said adjustable cleaning unit and normal vector of cleaned surface of said semiconductor substrate, said included angle being about 25-30 degrees.

7. The semiconductor substrate cleaning apparatus according to claim 1, wherein said adjustable cleaning unit is composed of an upper cover and a lower cover, said upper cover being fixed on top of said lower cover and at least a fluid accommodating space being formed between said upper cover and said lower cover, wherein said long slot is located on said upper cover and said lower cover further comprises at least a fluid inlet, one end of said fluid inlet being connected to a fluid source and another end being connected to said long slot via said fluid accommodating space.

8. The semiconductor substrate cleaning apparatus according to claim 1, wherein said adjustable cleaning unit further comprises a recycling apparatus for recycling said fluid sprayed out by said long slot.

9. The semiconductor substrate cleaning apparatus according to claim 1, wherein said vertical baseboard of said base unit is composed of an inner vertical baseboard and an outer vertical baseboard, said inner vertical baseboard including a slide track to support upward and downward movement of said outer vertical baseboard with respect to said inner vertical baseboard.

10. The semiconductor substrate cleaning apparatus according to claim 1, further comprising a displacement mechanism disposed on said working platform, said displacement mechanism comprising a semiconductor substrate fixing unit for fixing said semiconductor substrate and allowing said semiconductor substrate to move horizontally above said platform.

11. A reticle cleaning apparatus, comprising:
a working platform;
a base unit, composed of two vertical baseboards in parallel to each other, said vertical baseboard having a bottom end and a top end, said bottom end of said vertical baseboard being disposed on said working platform; and
an adjustable cleaning unit, pivotally disposed on said top end of said two vertical baseboards of said base unit, wherein said adjustable cleaning unit comprises a long slot for transmitting a fluid to a surface of a semiconductor substrate, wherein length of said long slot of said adjustable cleaning unit is about two-thirds of width of said reticle.

12. The reticle cleaning apparatus according to claim 11, wherein said fluid is gas.

13. The reticle cleaning apparatus according to claim 12, wherein said gas is selected from the group consisting of: inert gas, dry, cold air, nitrogen, and pure gas.

14. The reticle cleaning apparatus according to claim 11, wherein said fluid is liquid.

15. The reticle cleaning apparatus according to claim 11, wherein there is an included angle between said fluid sprayed out by said long slot of said adjustable cleaning unit and normal vector of said surface of said reticle, said included angle being about 25-30 degrees.

16. The reticle cleaning apparatus according to claim 11, wherein said adjustable cleaning unit is composed of an upper cover and a lower cover, said upper cover being fixed on top of said lower cover and at least a fluid accommodating space being formed between said upper cover and said lower cover, wherein said long slot is located on said upper cover and said lower cover further comprises at least a fluid inlet, one end of said fluid inlet being connected to a fluid source and another end being connected to said long slot via said fluid accommodating space.

17. The reticle cleaning apparatus according to claim 11, wherein said adjustable cleaning unit further comprises a recycling apparatus for recycling said fluid sprayed out by said long slot.

18. The reticle cleaning apparatus according to claim 11, wherein said vertical baseboard of said base unit is composed of an inner vertical baseboard and an outer vertical baseboard, said inner vertical baseboard including a slide track to support upward and downward movement of said outer vertical baseboard with respect to said inner vertical baseboard.

19. The reticle cleaning apparatus according to claim 11, further comprising a displacement mechanism disposed on said working platform, said displacement mechanism comprising a reticle fixing unit for fixing said reticle and allowing said reticle to move horizontally on said platform.

20. The reticle cleaning apparatus according to claim 11, further comprising another adjustable cleaning unit fixed to said working platform, wherein said other adjustable cleaning unit comprises a long slot for transmitting a fluid to another surface of said reticle.
